(19) United States
(12) Patent Application Publication
(10) Pub. No.: US 2013/0048808 A1
(43) Pub. Date: Feb. 28, 2013

(54) Tote hanger

(71) Applicant: Loren WIEBOLD, Benson, MN (US)

(72) Inventor: Loren WIEBOLD, Benson, MN (US)

(21) Appl. No.: 13/507,161

(22) Filed: Jun. 8, 2012

Related U.S. Application Data
(60) Provisional application No. 61/520,319, filed on Jun. 8, 2011.
(60) Provisional application No. 61/572,171, filed on Jul. 12, 2011.

(51) Int. Cl. F16M 13/02

(52) U.S. Cl. 248/205.1

(57) ABSTRACT

A tote hanger system supports a tote or bin hanging from a ceiling or exposed joist or beam. The system comprises two hangers, one for each end of the tote. Each hanger has a mechanism for securing the hanger to a ceiling or joist or beam, a vertical section to extend under a tote handle, a extending segment to accommodate a tote handle, and a horizontal bar to support the tote. The invention further comprises a method to hang totes using tote hangers.

### PRIORITY CLAIM

This application claims priority to U.S. Provisional patent application No. 61/520,319 entitled “Tote Hanger” and filed on Jun. 8, 2011, and U.S. Provisional patent application No. 61/572,171 entitled “Tote Hanger” and filed on Jul. 12, 2012.

### FIELD OF THE INVENTION

The present invention relates to storage devices. More particularly, the present invention relates to hangers for hanging large totes from ceilings or exposed joists or beams.

### BACKGROUND OF THE INVENTION

Plastic totes (or bins) are useful for storing a wide variety of items. The body of a tote is typically composed of a single piece of plastic, with handles at each end. When used with a cover, they can efficiently keep items protected from the elements. However, large totes are bulky. They require a lot of space, while often the items inside are used only infrequently. It is therefore desirable to provide new methods and devices to minimize storage space requirements.

### BRIEF DESCRIPTION OF THE INVENTION

A tote hanger system supports a tote or bin hanging from a ceiling or exposed joist or beam. The system comprises two hangers, one for each end of the tote. Each hanger has a mechanism for securing the hanger to a ceiling or joist or beam, a vertical section to extend under a tote handle, a extending segment to accommodate a tote handle, and a horizontal bar to support the tote. The invention further comprises a method to hang totes using tote hangers.

### BRIEF DESCRIPTION OF THE DRAWINGS

The accompanying drawings, which are incorporated into and constitute apart of this specification, illustrate one or more embodiments of the present invention and, together with the detailed description, serve to explain the principles and implementations of the invention.

In the drawings:

FIG. 1 shows a front view of first embodiment of a tote hanger.

FIG. 2 shows a perspective view of a first embodiment of a tote hanger.

FIG. 3 shows a first embodiment of a tote hanger system suspending one end of a tote from a ceiling joist. (not to scale)

FIG. 4 illustrates the meaning of “horizontal clearance region” and “vertical clearance region”.

FIG. 5 shows a second embodiment of a tote hanger.

FIG. 6 shows a close up view of the bracket for a second embodiment of the tote hanger.

FIG. 7 shows pairs of tote hangers (second embodiment) attached to a finished ceiling.

FIG. 8 shows totes suspended from the hangers of FIG. 7.

FIG. 9 shows a tote hangers (second embodiment) attached to a wall.

FIGS. 10-13 are mechanical drawings of presently preferred embodiments of the invention.

### DETAILED DESCRIPTION

Embodiments of the present invention are described herein in the context of a tote hanger system. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

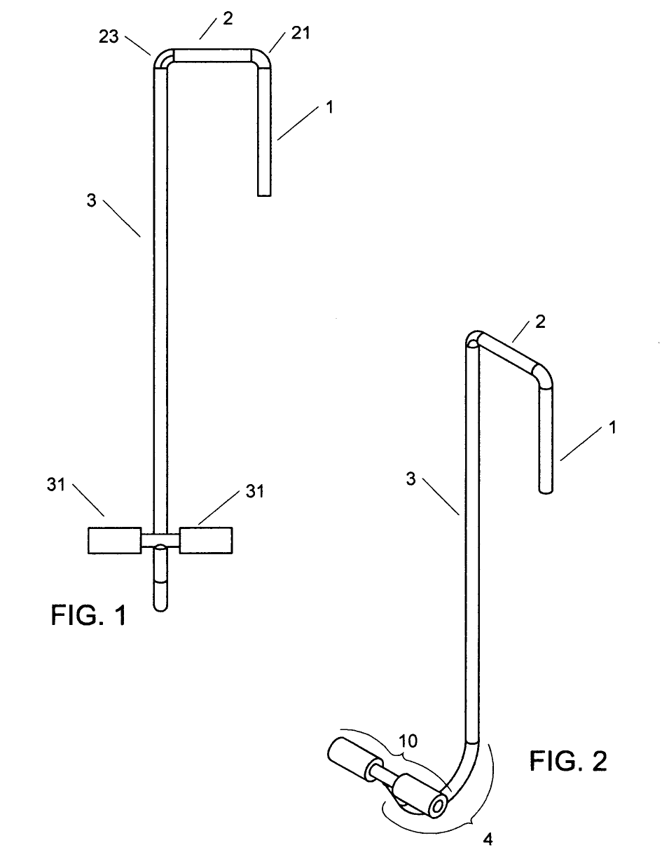

FIGS. 1 and 2 show a first embodiment of the present invention. This embodiment of a tote hanger comprises a first vertical section or segment 1, a horizontal section 2 and a second vertical section 3. These three sections are substantially coplanar. Together, segment 1, section 2, and the upper portion of section 3 comprise the ceiling attachment mechanism. Extending perpendicularly to the plane defined by the first three sections is a fourth section 4. Section four as shown is curved, but it will be appreciated that this perpendicular (or extending) section can be configured in a variety of ways to extend from the plane. Attached horizontally to the distal extend of section four is handle support bar 10. Handle support bar 10 and section four 4 are jointly configured so that handle support bar 10 can fit into a tote handle without interference from the rest of the tote hanger. I.e., section four 4 preferably attaches to the bottom side of handle support bar 10, section four has a region below the handle support to provide clearance between the tote and section four (a vertical clearance region). As shown in the figures, the vertical clearance region may be achieved by having a downward curve in section four. Section four also extends sufficiently from the plane to provide a horizontal clearance region between the tote and vertical section 3.

Sections one through four are substantially rigid and may be fabricated as a single piece, e.g. from a metal rod or molded plastic or cast aluminum. Handle support bar 10 is also substantially rigid, and may be a metal rod welded to the distal end of section four, or molded plastic or cast aluminum formed a single piece with the other sections.

This first embodiment of a tote hanger may also comprise a bearing (not shown) over horizontal section 2. The bearing is preferably a plastic or metal cylinder slightly less than the length of section two. During manufacture the bearing may be placed over section two after either bend 21 or bend 23 is made. When the second of the two bends is made, the bearing is fixed over section two. Alternatively, a snap-on bearing may be used. The bearing allows a user to more easily slide a suspended tote along a joist or beam.

FIG. 1 shows a first embodiment where sections one and two extend to the left of section three when viewed from the front. It will be appreciated that the invention includes embodiments where sections one and two extend to the left side. In practice only one embodiment is needed to suspend a tote by a pair of tote hangers. I.e., the pair will be oppositely oriented along abeam so that the handle supports can be inserted into the tote handles. However, it may be Preferable to provide pairs of left and right handed tote hangers for asthetic purposes.

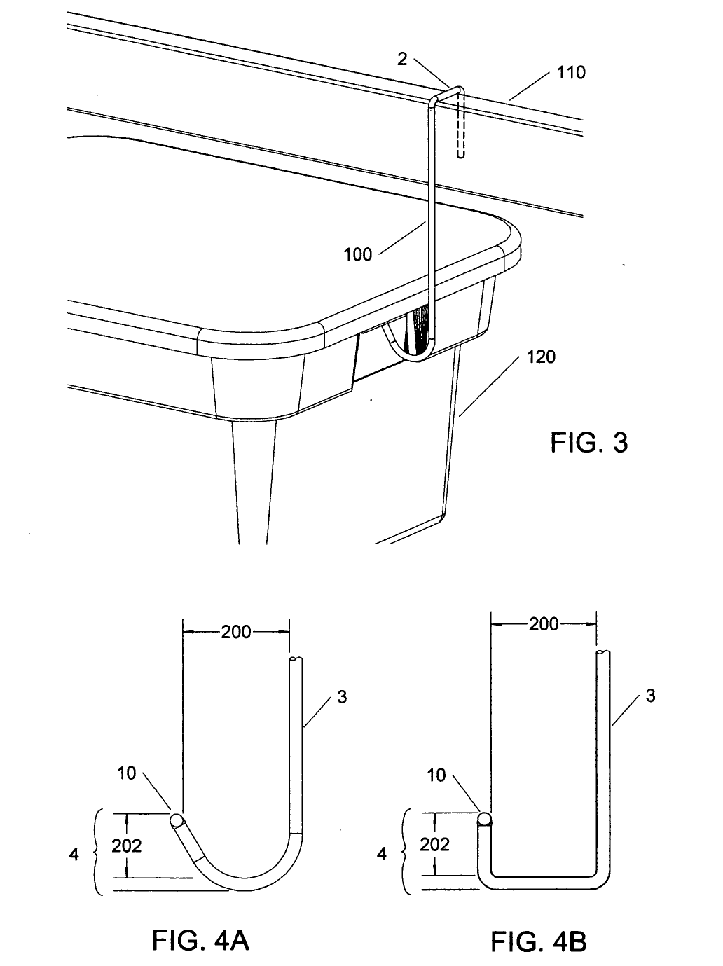

FIG. 3 depicts a tote hanger suspending one end of a tote from a ceiling joist. Tote hanger 100 hangs over ceiling joist 110, with horizontal section two 2 over the top of the joist. The handle support bar fits into the handle of tote 120. When a bearing is present, the hanger 110 and tote 120 can slide along the joist 110 more easily.

Tote hangers of the first embodiment of the invention are preferably sized to fit over typical garage ceiling joists, i.e., beams approximately 1½ inches wide. Therefore, section 1 is preferably between about 3 to 4 inches long, and section two is preferably between 1½ to 1¾ inches long. To accommodate 2×4's, 2×6's and 2×8's, the distance from the top of section 3 to the bottom of section 4 is Preferably between about 6 to 14 inches, and most preferably about 10 inches to accommodate 2×4's. The dimensions of all sections and the handle support may be optimized depending on the size of the beam and the configuration of the handles on the tote. The vertical clearance region of section four is preferably between about 1 to 2 inches. As shown in FIG. 1, the vertical clearance region is the area between about the 1¾ and 3 inch marks on the ruler. The horizontal clearance region is between about ½ to two inches. The handle support is preferably between about 2 to four inches long.

All embodiments of the hanger may be made from bendable and easily weldable metal rods having a diameter between about ⅛ and ⅜ diameter. The most preferred diameter is ¼ inch. It will be appreciated that other materials, such as molded plastic or cast aluminum, may also be used. However constructed, it is to be understood that the terms “rod” and “bar” and “section” and “segment” shall refer to a section of the hanger, even though multiple sections of the hanger are formed together as a single part.

Additional features may be incorporated into the coat hanger. Protective tips 31 made of rubber, wood, or plastic may bit fitted over the ends of handle support bar 10. The hanger may be coated with paint, plastic, or resin for protective and decorative purposes.

FIGS. 4A and 4B illustrate the meaning of “horizontal clearance region” and “vertical clearance region”. In FIG. 4A, vertical section 3 is contiguous with extending section 4. Extending section 4 is shaped to provide a horizontal clearance region 200 from vertical section 3, as well as a vertical clearance region 202 from the top of handle support bar 10 down to the upper side of the lower portion of extending section 4. FIG. 4B shows an extending section of a different shape that still has both a horizontal clearance region 200 and a vertical clearance region 202.

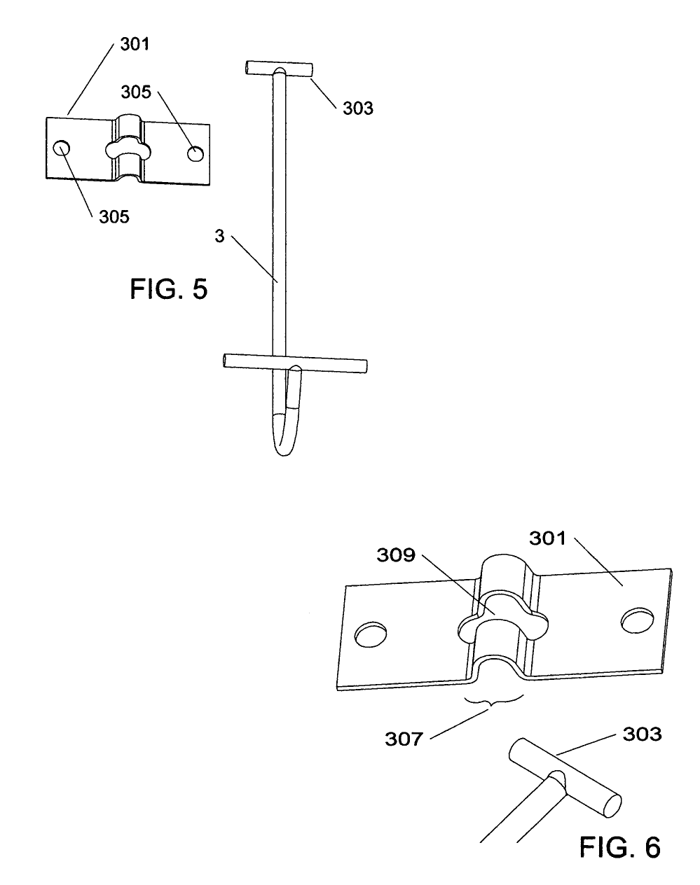

FIG. 5 shows a second embodiment of the tote hanger. This embodiment may be used on the underside of exposed ceiling joists or beams, but has the added advantage of also being attachable to finished ceilings (See FIGS. 7 and 8). In the second embodiment, the ceiling attachment mechanism is a bracket 301 that accommodates an attachment bar 303 on the upper end of vertical section 3. Bracket 301 includes holes 305 for securing the bracket to a ceiling joist or beam (preferably using screws), either directly to the beam or through a layer of sheetrock or other finishing material (see FIG. 7).

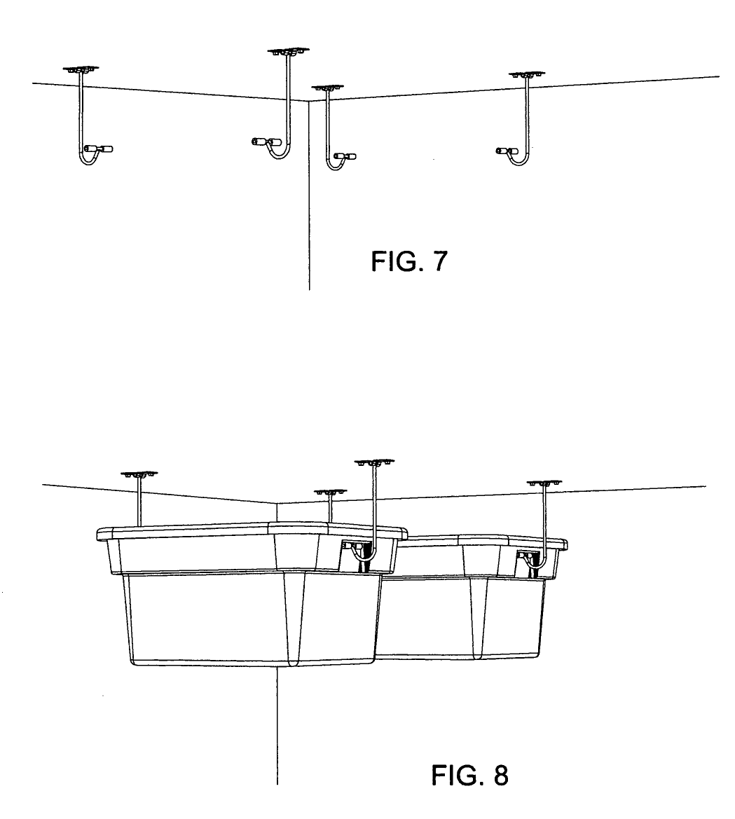

FIG. 6 shows a close un view of the bracket for a second embodiment of the tote hanger. Bracket 301 comprises a folded region 307 to accommodate the attachment bar 303. Folded region 307 includes an opening 309 for insertion of the attachment bar.

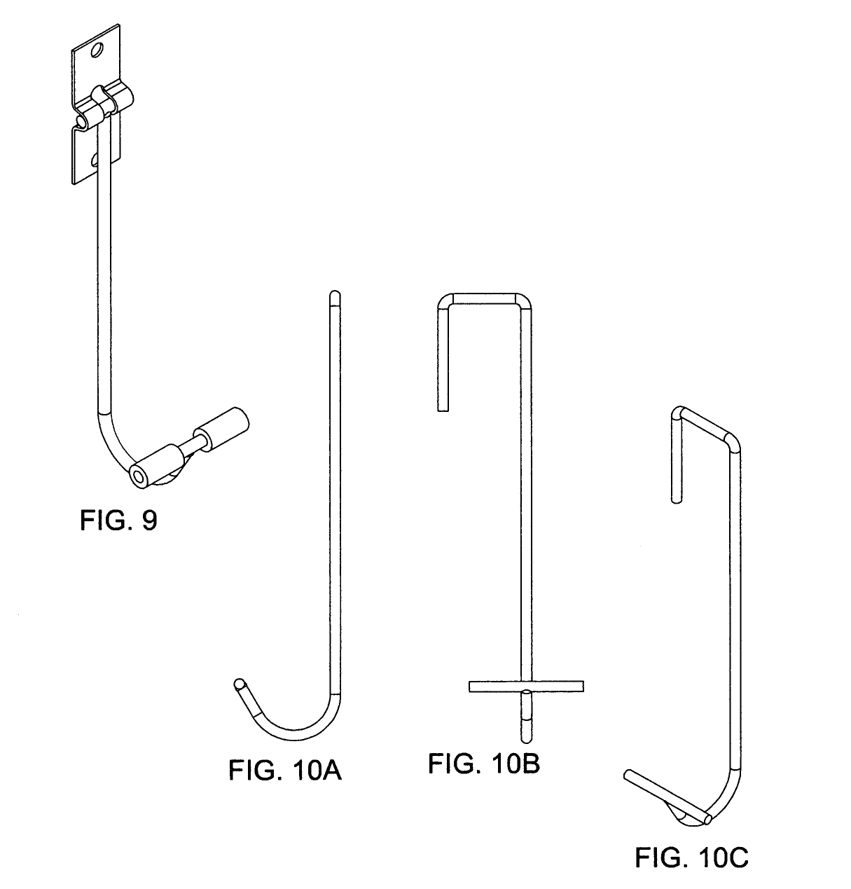

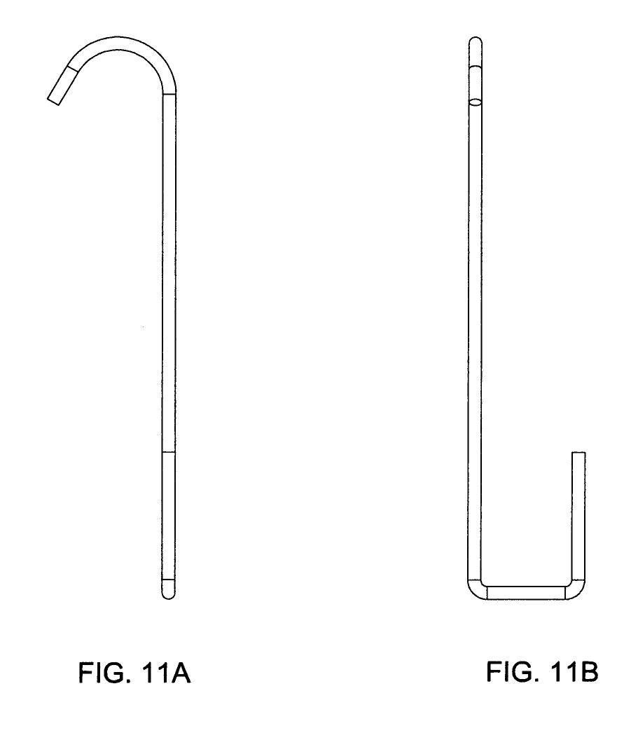

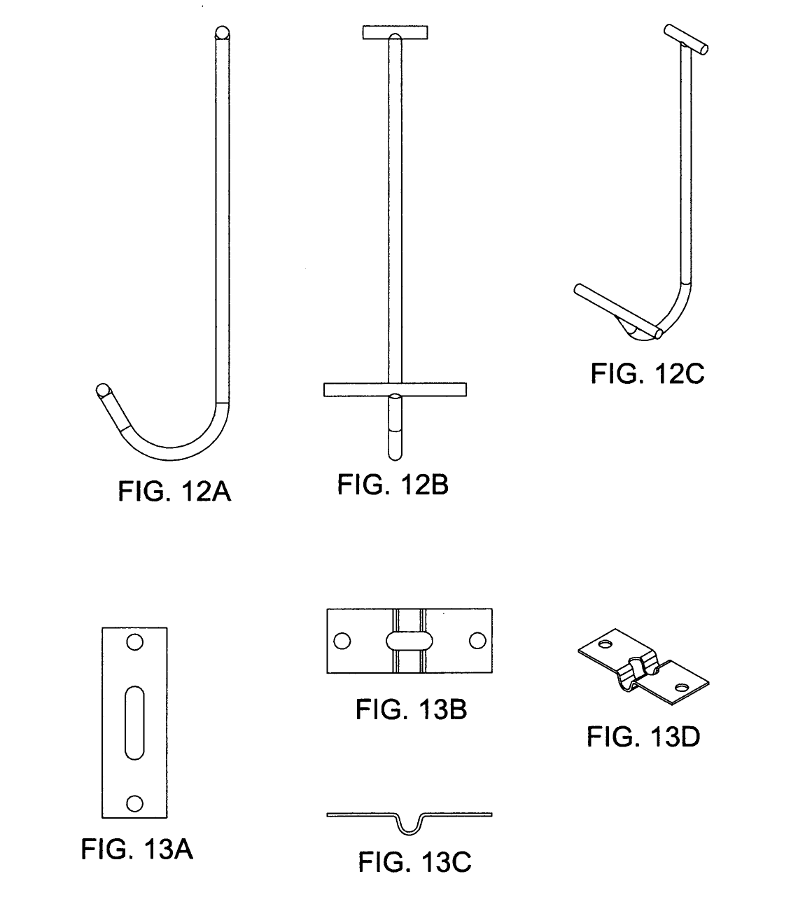

Because the second embodiment allows the tote hanger to pivot from the bracket, this embodiment may be employed in ways other than attachment to a ceiling. For example, FIG. 9 shows the second embodiment attached to a wall.

Most generally, the tote hanger comprises a ceiling attachment mechanism (e.g. the planar region of the first embodiment or the bracket and attachment bar of the second embodiment); a vertical segment; and extending segment defining a horizontal clearance region and a vertical clearance region, and a handle support bar. The vertical clearance region of the extending segment is preferably between about 1 to 2 inches. The horizontal clearance region is between about ½ to two inches. The handle support bar is preferably between about 2 to four inches long. Most preferably the handle support bar is about 2.5 inches lone to distribute the weight of the tote over the entire support bar while accommodating many commercially available totes, and its ends are covered with plastic tips to protect the tote. The vertical clearance region is most preferably about one inch, and the horizontal clearance region is most preferably about 1.8 inches. The extending segment is preferably configured as a curve. The vertical segment is designed to provide a clearance of between about two to twelve inches, or more preferably three to six inches from the top of a hanging tote to the point of attachment on the ceiling.

The invention also comprises a method of hanging a tote comprising attaching a pair of tote hangers to a ceiling or exposed beam or joist, and hanging a tote from the pair of tote hangers.

In one aspect, the invention includes a hanger comprising a hanger comprising: a first substantially rigid rod having a diameter between about ⅛ inch and ⅜ inch and having four sections, where the first section is a vertical section between about 3 inches and 4 inches in length, the second section is a horizontal section of sufficient length to span a ceiling beam (between about 1½ inches and 1¾ inches), the third section is a vertical section between about 5 inches and 13 inches in length, where the first three sections are substantially coplanar, and a fourth section extending perpendicularly from the Diane and defining a horizontal clearance region and a vertical clearance region; and a second substantially rigid rod having a horizontal orientation and being fixed to the distal end of said fourth section. Section 4 may define a vertical clearance region of between about 1 and 2 inches, and a horizontal clearance region between about ½ and to 2 inches. Section 4 may define an arc. The hanger may further comprise a rotatable. bearing over section two. Preferably the distance between the top of the vertical section and the bottom of the extending section is between about 6 to 14 inches. More preferably the distance is between about nine and ten inches.

In another aspect, the invention includes a method of optimizing storage space, where the method comprises selecting a beam size, selecting a tote handle configuration, and designing the dimensions of the hanger accordingly.

In another aspect the invention is a tote hanger comprising a first substantially rigid rod having a diameter between about ⅛ inch and ⅜ inch and having two sections, where the first section is a vertical section between about 5 inches and 11 inches in length, and an extending section defining a horizontal clearance region and a vertical clearance region, where the first and second sections are coplanar; a second substantially rigid rod having a diameter between about ⅛ inch and ⅜ inch and having a horizontal orientation and being fixed to the distal end of said extending section perpendicular to the Diane defined by the two sections of the first rod; and a third substantially rigid rod having a diameter between about ⅛ inch and ⅜ inch and having a horizontal orientation and being fixed to the upper end of said vertical section perpendicular to the plane defined by the two sections of the first rod. The vertical clearance region may be between about 1 and 2 inches, and the horizontal clearance region may be between about ½ and to 2 inches. The extending section may define an arc. The hanger may further comprise a bracket capable of attachment to a ceiling beam or joist, said bracket comprising a folded region accommodating said third rigid rod. Preferably the distance between the top of the vertical section and the bottom of the extending section is between about 7 to 14 inches. More preferably the distance is between about nine and ten inches.

In another aspect the invention is a tote hanger comprising a ceiling attachment mechanism; a vertical segment; an extending segment defining a horizontal clearance region and a vertical clearance region; and a handle support bar. The vertical clearance region of the extending segment is preferably between about 1 to 2 inches. The horizontal clearance region is between about ½ to two inches. The handle support is preferably between about 2 to four inches long. Most preferably the handle support bar is about 2.5 inches long to distribute the weight of the tote over the entire support bar which accommodating many commercially available totes, and its ends are covered with plastic tips to protect the tote. The vertical clearance region is most preferably about one inch, and the horizontal clearance region is most preferably about 1.8 inches. The extending segment is preferably configured as a curve. The extending section may define an arc. The vertical segment is designed to provide a clearance of between about three to 12 inches from the top of a hanging tote to the point of attachment on the ceiling, and more preferably about. Preferably the distance between ceiling and the bottom of the extending section is between about 5 to 14 inches. More preferably the distance is between about eight and ten inches.

In another aspect, the invention is a method of hanging a tote comprising attaching a pair of tote hangers to a ceiling or to an exposed joist or beam, and suspending the tote from the pair of hangers, where the hangers are as described herein.

Both the handle support bar and the attachment bar are centered to balance the tote hanger and the hanging tote.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A hanger comprising:
a first substantially rigid rod having a diameter between about ⅛ inch and ⅜ inch and having four sections, where the first section is a vertical section between about 3 inches and 4 inches in length, the second section is a horizontal section of sufficient length to span a ceiling beam, the third section is a vertical section between about 5 inches and 14 inches in length, where the first three sections are substantially coplanar, and a fourth section extending perpendicularly from the plane and defining a horizontal clearance region and a vertical clearance region; and a second substantially rigid rod having a horizontal orientation and being fixed to the distal end of said fourth section.

2. The hanger of claim 1, where section 4 defines a vertical clearance region of between about 1 and 2 inches, and a horizontal clearance region of about 2 inches.

3. The hanger of claim 2, where section 4 defines an arc.

4. A hanger system comprising:
a hanger unit having a first substantially rigid rod having a diameter between about ⅛ inch and ⅜ inch and having two sections, where the first section is a vertical section between about 5 inches and 11 inches in length, and a second section defining a horizontal clearance region and a vertical clearance region, where the first and second sections are coplanar; a second substantially rigid rod having a diameter between about ⅛ inch and ⅜ inch and having a horizontal orientation and being fixed to the distal end of said second section perpendicular to the plane defined by the two sections of the first rod; and a third substantially rigid rod having a diameter between about ⅛ inch and ⅜ inch and having a horizontal orientation and being fixed to the upper end of said first section perpendicular to the plane defined by the two sections of the first rod; and a bracket capable of attachment to a ceiling beam or joist, said bracket comprising a folded region accommodating said third rigid rod.

5. The hanger of claim 4, where the second section defines a vertical clearance region of between about 1 and 2 inches, and a horizontal clearance region of about 2 inches.

6. The hanger of claim 2, where the second section defines an arc.
